(19) United States
(12) Patent Application Publication
(10) Pub. No.: US 2026/0208461 A1
(43) Pub. Date: Jul. 23, 2026

(54) PRODUCT HANDLING DEVICE, AND METHOD FOR HANDLING STACKS OF PACKAGING BLANKS FOR A LOADING OF A CARDBOARD MAGAZINE

(71) Applicant: Syntegon Packaging Systems AG, Beringen (CH)

(72) Inventors: Andreas Bartholdi, Wagenhausen (CH); Alexander Joehl, Beringen (CH)

(21) Appl. No.: 19/454,641

(22) Filed: Jan. 21, 2026

(30) Foreign Application Priority Data
Jan. 21, 2025 (DE) 10 2025 102 053.1

(51) Int. Cl. B31B 50/06; B65H 43/00

(52) U.S. Cl. CPC B31B 50/066; B65H 43/00; B65H 2553/45

(57) ABSTRACT

A product handling device for a handling of stacks of packaging blanks includes at least one handling unit having support and/or contact elements, which have a support surface against which, at least during handling, the stack of packaging blanks can be placed with a main extension surface, and at least one detection unit which is configured for the detection of at least one packaging blank characteristic variable. The at least one detection unit includes at least one detection element for a detection of a packaging blank characteristic variable that is configured as a contour of at least one packaging blank of the packaging blanks, and includes at least one further detection element for a detection of a packaging blank characteristic variable that is configured as a position of a cutout between two side tabs of a packaging blank of the packaging blanks.

### CROSS-REFERENCE TO RELATED APPLICATION

This patent application is based on and claims priority to German patent application DE 10 2025 102 053.1, filed on Jan. 21, 2025, the contents of which are incorporated herein by reference.

### BACKGROUND

The invention concerns a product handling device, in particular a cardboard magazine loading device, for a handling of stacks of packaging blanks, in particular of cardboard blanks, preferably for an automatic loading of a cardboard magazine of a packaging machine with stacks of packaging blanks, with at least one handling unit comprising support and/or contact elements which have a support surface against which, at least during handling, the stack of packaging blanks can be placed with a main extension surface.

Such product handling devices are known, for example, under the product name Cermex FlexiLoad™ of the company Sidel International S.A. In the known product handling devices, the stacks of packaging blanks are held by means of the support and/or contact elements via a force-fit connection acting parallel to a main extension surface of the stacks of packaging blanks and/or via a form-fit connection acting perpendicularly to the main extension surface of the stacks of packaging blanks, in particular in that the stacks of packaging blanks are clamped between at least two support and/or contact elements. This may lead to an inaccurate orientation of the packaging blanks in the cardboard magazine, since it is possible that the stacks of packaging blanks slip between the two support and/or contact elements if there is an insufficient frictional force along the main extension surface of the stacks of packaging blanks. Moreover, the stacks of packaging blanks, in particular in the case of an implementation of the packaging blanks with a smooth surface, may slip between the support and/or contact elements during handling of the packaging blanks by the already known product handling devices as a result of an undesired contact, which preferably causes a force impulse from the outside onto the stack of packaging blanks; this may also contribute to an inaccurate positioning of the packaging blanks.

Furthermore, from DE 10 2022 134 697 A1, US 2023/0150707 A1, DE 10 2022 117 889 A 1 and DE 10 2020 124 945 A1, product handling devices for a handling of stacks of packaging blanks, with at least one handling unit comprising support and/or contact elements which have a support surface against which, at least during handling, the stack of packaging blanks can be placed with a main extension surface, and with at least one detection unit that is configured to detect at least one packaging blank characteristic variable, are already known.

The objective of the invention is in particular to provide a generic product handling device, a generic method and/or a generic packaging machine having improved properties with regard to a simple and safe handling of packaging blanks, in particular by a reliable and precise detection of packaging blank characteristic variables. The objective is achieved according to the invention.

### SUMMARY

The invention is based on a product handling device, in particular a cardboard magazine loading device, for a handling of stacks of packaging blanks, in particular of cardboard blanks, preferably for an automatic loading of a cardboard magazine of a packaging machine with stacks of packaging blanks, with at least one handling unit comprising, in particular three, support and/or contact elements which, in particular in each case, have a support surface against which, at least during handling, the stack of packaging blanks can be placed with a main extension surface, in particular a main extension surface of an, in particular lowermost, packaging blank of the stack of packaging blanks facing the support and/or contact elements, and with at least one detection unit which is configured to detect at least one packaging blank characteristic variable, in particular a contour of the packaging blanks and/or a position of the packaging blanks on or at a transport or storage device, preferably a pallet.

It is proposed that the detection unit comprises at least one, in particular optical, detection element for a detection of a packaging blank characteristic variable that is realized as a contour of at least one packaging blank of the packaging blanks, and comprises at least one further, in particular optical, detection element for a detection of a packaging blank characteristic variable that is realized as a position of a cutout, in particular a slot, between two side tabs of a packaging blank of the packaging blanks. The implementation of the product handling device according to the invention advantageously enables a reliable detection of a packaging blank characteristic variable for a reliable form-fitting holding of the packaging blanks by means of the support and/or contact element, in particular by means of the support and/or contact elements. A high degree of automation is advantageously achievable. Advantageously, a checking of a stack quality of the packaging blanks is advantageously enabled, in particular in an early processing stage of the packaging blanks, which advantageously allows counteracting a machine stop. Advantageously, a reliable detection of relevant packaging blank characteristic variables for a handling of packaging blanks by the handling unit can be realized. Advantageously, simple and safe handling of packaging blanks is enabled. Advantageously, precise receiving and precise depositing of the packaging blanks in the cardboard magazine are enabled. Advantageously, a high productivity of the packaging machine comprising the product handling device can be realized. Advantageously, a reliable handling, in particular gripping, of packaging blanks is enabled substantially independently of an orientation and/or arrangement of packaging blanks on or at a transport or storage device, preferably a pallet, in particular since an orientation and/or arrangement of packaging blanks on or at a transport or storage device, preferably a pallet, can advantageously be detected by the detection unit.

The detection unit may be realized as an optical, an acoustic and/or a tactile detection unit. For example, the detection unit may comprise at least one or several detection element(s) which is/are realized as (a) tactile sensor(s), such as for example a measuring probe or the like. Alternatively or additionally, it is conceivable that the detection unit comprises at least one or several acoustic detection element(s) which is/are realized as (an) acoustic sensor(s), such as for example (a) radar sensor(s) or the like. Preferentially, the detection unit comprises at least one or several optical detection element(s) which is/are realized as (an) optical sensor(s), such as for example as (a) laser sensor(s), as (a) LiDAR sensor(s) or the like. The optical detection element(s) is/are preferably realized differently from a CCD sensor or a CMOS sensor. The detection unit is preferably configured at least for detecting a contour, in particular an outer contour of individual packaging blanks, a position of individual packaging blanks relative to one another, an orientation of the packaging blanks relative to one another and/or relative to the transport or storage device, preferably pallet, a maximum material thickness of individual packaging blanks, a maximum height of a stack of packaging blanks, a position of an intermediate layer between several stacks of packaging blanks, a position of one or several cutout(s), in particular slot(s), between two side tabs of a packaging blank, a distance of cutouts relative to one another, and/or other packaging blank characteristic variables deemed expedient by someone skilled in the art. “Configured” is in particular to mean specially implemented, specially designed, specially equipped and/or specially programmed. By an object being configured for a certain function is in particular to be understood that the object fulfills and/or carries out this certain function in at least one application state and/or operation state. The detection unit may be arranged at the handling unit, in particular at a base body, or may be arranged separately from the handling unit. The detection unit may be supported movably at the base body of the handling unit or may be fastened stationarily at the base body of the handling unit, in particular so as to be movable together with the handling unit. It is also conceivable that the detection unit is movable separately from, in particular independently of, the handling unit. Further arrangements of the detection unit, deemed expedient by someone skilled in the art, are likewise conceivable, such as for example an arrangement of the detection unit at a drone, at an automated guided vehicle (AGV), at an, in particular additional, industrial robot or the like. Preferably, a pre-adjustment of a position of the support and/or contact elements relative to a base body of the handling unit is carried out depending on packaging blank characteristic variables detected by the detection unit, in particular in order to enable a simple and quick adaption to packaging blanks of different sizes, such as for example in the case of a format change or the like, and/or to enable safe and reliable handling, in particular gripping, of the packaging blanks. The product handling device preferably comprises an open-loop or closed-loop control unit which is connected to the detection unit in terms of data technology, wherein the open-loop or closed-loop control unit is configured for open-loop or closed-loop controlling of the handling unit depending on packaging blank characteristic variables detected by the detection unit. An “open-loop or closed-loop control unit” is in particular to be understood as a unit having at least one electronics control unit. An “electronics control unit” is in particular to mean a unit with a processor unit and with a memory unit as well as with an operating program stored in the memory unit.

The product handling device is preferably realized as a cardboard magazine loading device that is configured for a handling of stacks of packaging blanks, in particular cardboard blanks. Preferably, the product handling device is configured for an automatic loading of a cardboard magazine of a packaging machine with stacks of packaging blanks, in particular cardboard blanks. Preferably, at least one, in particular at least two, of the support and/or contact elements, in particular in each case, comprises, in particular comprise, a side contact surface which extends transversely, in particular at least substantially perpendicularly, to the support surface and against which, at least during handling, the stack of packaging blanks can be placed with a side surface that extends transversely to the main extension surface. Preferably, the stack of packaging blanks can be held by means of the at least one of the support and/or contact elements, in particular by means of at least two of the support and/or contact elements, via a form-fit connection with the handling unit, which acts at least substantially parallel to the main extension surface of the stack of packaging blanks. However, it is also conceivable that the stack of packaging blanks can additionally be held by means of the at least one of the support and/or contact elements, in particular by means of at least two of the support and/or contact elements, via a form-fit connection acting at least substantially perpendicularly to the main extension surface of the stack of packaging blanks. “Substantially parallel” is in particular to mean an orientation of a direction relative to a reference direction, in particular in a plane, wherein the direction differs from the reference direction by in particular less than 8°, advantageously less than 5° and particularly advantageously less than 2°. The product handling device can preferably be arranged on an industrial robot, in particular on a tool interface of the industrial robot, or the product handling device preferably comprises at least one industrial robot on which preferably at least the handling unit can be arranged, in particular on a tool interface of the industrial robot. The industrial robot is preferentially realized as a multi-axis robot having a functionality and an implementation already known to someone skilled in the art. The industrial robot may be realized as a stationary industrial robot or as a mobile industrial robot. The product handling device or at least the handling unit is preferably, by means of the industrial robot, supported so as to be movable rotationally around and/or translationally along at least one movement axis, preferably three movement axes, in particular relative to the packaging machine and/or relative to a ground on which the industrial robot is arranged. Preferably, the handling unit comprises the base body, on which a connection interface of the handling unit is arranged for an, in particular form-fit and/or force-fit, connection of the handling unit to the industrial robot, in particular to the tool interface of the industrial robot. Preferentially, the handling unit is, in particular detachably, fixed at the tool interface of the industrial robot via the connection interface. The connection interface may, in particular in addition to a fixing of the handling unit at the industrial robot, be configured for a power supply and/or a data connection, preferably in a manner already known to someone skilled in the art. However, it is also conceivable that the handling unit, in particular in addition to the connection interface, comprises at least one transmission interface, which is in particular realized separately from the connection interface, for a power and/or data transmission, in particular in a manner already known to someone skilled in the art.

The handling unit is preferably configured for a handling of stacks of packaging blanks. In particular, the handling unit is configured for a lifting/removal of a stack of packaging blanks from a plurality of packaging blanks arranged on or at the transport or storage device, in particular the pallet, and for a subsequent transfer of the lifted/removed stack of packaging blanks to a packaging machine, in particular to a cardboard magazine or a feed transport unit, preferably a so-called feeder, of the packaging machine. Preferentially, the plurality of packaging blanks arranged on or at the transport or storage device, in particular the pallet, is arranged on or at the transport or storage device in an ordered and/or stacked manner that is already known to someone skilled in the art. The handling unit is preferably configured for a de-stacking/removal of stacks of packaging blanks as far as a respective intermediate layer of the plurality of packaging blanks arranged on or at the transport or storage device, in particular the pallet. A function and implementation of intermediate layers at the transport or storage device, in particular the pallet, are already known to someone skilled in the art and are preferably used for a stabilization of the plurality of packaging blanks arranged on or at the transport or storage device, in particular the pallet, during for example a transport with a truck, in a manner already known to someone skilled in the art.

For a handling of the stack of packaging blanks, the handling unit preferably comprises at least the, in particular three, support and/or contact elements. Two of the, in particular three, support and/or contact elements are preferably realized as side-tab-slot engagement elements which, for a handling of the stack of packaging blanks, are insertable into a cutout, in particular into a slot, between two side tabs of the packaging blanks. At least one of the, in particular three, support and/or contact elements is preferably realized as a gripping finger, in particular as a primary gripping finger, which can be brought into contact/is brought into contact with the stack of packaging blanks before the side-tab-slot engagement elements. Preferentially, the, in particular three, support and/or contact elements are supported movably at the base body of the handling unit, in particular relative to one another, relative to the industrial robot and/or relative to the packaging machine. Preferably, individual movement axes of the, in particular three, support and/or contact elements each extend at least substantially parallel to a main extension plane of the handling unit. A “main extension plane” of an element or of a structural unit is in particular to mean a plane which extends parallel to a largest side surface of a smallest imaginary cuboid just still completely enclosing the element or the structural unit, and in particular extends through the center point of the cuboid. Preferably, at least two movement axes of the, in particular three, support and/or contact elements, in particular the movement axes of the support and/or contact elements realized as side-tab-slot engagement elements, extend coaxially. At least one of the movement axes of the, in particular three, support and/or contact elements extends transversely, in particular at least substantially perpendicularly, to at least one of the movement axes of the, in particular three, support and/or contact elements, in particular to the two coaxially extending movement axes of the, in particular three, support and/or contact elements. The, in particular three, support and/or contact elements may be supported so as to be movable rotationally around and/or translationally along the respective movement axis, in particular relative to the base body of the handling unit. The, in particular three, support and/or contact elements may be supported at the base body so as to be movable steplessly or stepwise. It is also conceivable that the, in particular three, support and/or contact elements are supported at the base body so as to be movable in a spring-loaded manner, in particular in order to counteract a damage to the stack of packaging blanks during a handling by the handling unit. At least two of the support and/or contact elements are preferably arranged in alignment with one another, in particular when viewed along a direction that runs at least substantially parallel to the main extension plane of the handling unit.

In a state when the stack of packaging blanks is arranged at the handling unit, the main extension surface of the stack of packaging blanks preferably extends at least substantially parallel to the main extension plane of the handling unit. The, in particular three, support and/or contact elements preferably each comprise a support surface against which, at least during handling, the stack of packaging blanks, in particular a lowermost packaging blank of the stack of packaging blanks, can be placed, in particular rests, with its main extension surface. Preferentially, at least two, in particular all, of the support and/or contact elements each comprise a side contact surface which extends transversely, in particular at least substantially perpendicularly, to the support surface and against which, at least during handling, the stack of packaging blanks can be placed, in particular rests, with a side surface extending transversely to the main extension surface. The expression “substantially perpendicularly” is in particular meant to define an orientation of a direction relative to a reference direction, wherein the direction and the reference direction, in particular when viewed in a projection plane, include an angle of 90° and the angle has a maximum deviation of in particular less than 8°, advantageously less than 5° and particularly advantageously less than 2°. Preferentially, in a state when the stack of packaging blanks is arranged at the handling unit, all side contact surfaces of the support and/or contact elements are arranged on the side of the support and/or contact elements that faces towards the stack of packaging blanks. Preferably, a form-fit connection between the support and/or contact elements and the stack of packaging blanks, which acts along a direction that runs at least substantially parallel to the main extension surface of the stack of packaging blanks, can be realized by means of the side contact surfaces of the support and/or contact elements.

The detection unit preferentially comprises the at least one, in particular optical, detection element and the at least one further, in particular optical, detection element, wherein the detection element is configured for a detection of at least one packaging blank characteristic variable and the further detection element is configured for a detection of at least one further packaging blank characteristic variable. The, in particular optical, detection element preferably has an implementation different from the further, in particular optical, detection element, in particular at least with regard to a structure, wherein an operating principle may be the same, for example an implementation of the, in particular optical, detection element as a line laser and of the further, in particular optical, detection element as a distance laser sensor, or the like. Preferentially, the, in particular optical, detection element and the further, in particular optical, detection element are arranged spaced apart from one another, in particular at the base body of the handling unit. The, in particular optical, detection element and/or the further, in particular optical, detection element may be arranged so as to be positionally fixed, preferably relative to one another, in particular at the base body of the handling unit. It is also conceivable that the, in particular optical, detection element and/or the further, in particular optical, detection element are/is arranged so as to be movable, preferably relative to one another, in particular at the base body of the handling unit. Preferably, the detection unit comprises a single, in particular optical, detection element and at least two further, in particular optical, detection elements. However, it is also conceivable that the detection unit comprises a different number, deemed expedient by someone skilled in the art, of detection elements and further detection elements. For example, the, in particular optical, detection element is configured for detecting a contour, in particular an outer contour, of individual packaging blanks, a position of individual packaging blanks relative to one another, an orientation of the packaging blanks relative to one another and/or relative to the transport or storage device, preferably the pallet, or the like. The further, in particular optical, detection element is configured, for example, for detecting a maximum material thickness of at least one packaging blank, a maximum height of a stack of packaging blanks, a position of an intermediate layer between several stacks of packaging blanks, a position of one or several cutout(s), in particular slot(s), between two side tabs of a packaging blank, a distance of cutouts, or the like. The implementation of the product handling device according to the invention advantageously enables a reliable detection of relevant packaging blank characteristic variables for a handling of packaging blanks by the handling unit. Advantageously, for a reliable form-fitting holding of the packaging blanks by the support and/or contact element, in particular by the support and/or contact elements, a reliable detection of a packaging blank characteristic variable is achievable.

According to the invention, it is proposed that the detection unit comprises at least the, in particular optical, detection element for a detection of a packaging blank characteristic variable that is realized as a contour of at least one packaging blank of the packaging blanks, and comprises at least the further, in particular optical, detection element for a detection of a packaging blank characteristic variable that is realized as a position of a cutout, in particular a slot, between the two side tabs of the packaging blank of the packaging blanks. The detection unit preferably comprises a single optical detection element, which is configured for detecting a packaging blank characteristic variable that is realized as a contour of at least one packaging blank of the packaging blanks, and comprises at least two further optical detection elements, which are configured for detecting respectively one packaging blank characteristic variable that is realized as a position of a cutout, in particular a slot, between two side tabs of a packaging blank of the packaging blanks. The implementation of the product handling device according to the invention advantageously allows realizing a reliable detection of relevant packaging blank characteristic variables for a handling of packaging blanks by the handling unit. Advantageously, a reliable detection of a packaging blank characteristic variable for a reliable form-fitting holding of the packaging blanks by the support and/or contact element, in particular by the support and/or contact elements, is achievable. A high degree of automation is advantageously achievable. Advantageously, a checking of a stack quality of the packaging blanks is advantageously enabled, in particular in an early processing stage of the packaging blanks, which advantageously allows counteracting a machine stop.

Furthermore, it is proposed that the detection unit comprises the at least one optical detection element, which is realized as a laser scanner/laser profile sensor, and comprises the at least one further optical detection element, which is realized as a laser distance sensor. The optical detection element is preferably arranged, in particular at the base body of the handling unit, spaced apart from the further optical detection element(s) along a direction that runs at least substantially parallel to a movement axis of at least one separation element of the handling unit. The two further optical detection elements are preferably each realized as a laser distance sensor. Preferentially, the two further optical detection elements are arranged, in particular at the base body of the handling unit, spaced apart from one another along a direction that runs at least substantially parallel to a movement axis of at least one of the support and/or contact elements. The implementation of the product handling device according to the invention advantageously allows realizing a robust measurement arrangement, the measurement accuracy of which is advantageously not influenceable much by extraneous light. Advantageously, a reliable detection of relevant packaging blank characteristic variables is also achievable in the case of printed packaging blanks. It is advantageously possible to dispense with special markings on the packaging blanks, which are otherwise used in already known product handling devices in order to enable a handling of the packaging blanks by means of the already known product handling devices. Advantageously, slipped packaging blanks can be reliably detected. Advantageously, a statement with regard to a quality of the stack of packaging blanks to be handled is enabled. Advantageously, depth information can be detected in order to determine a maximum height of a stack of packaging blanks that is to be handled. Preferably, few movements/detection steps are sufficient to enable a precise detection of packaging blank characteristic variables. It is advantageously possible to realize a reliable detection of relevant packaging blank characteristic variables for a handling of packaging blanks by the handling unit. Advantageously, for a reliable form-fitting holding of the packaging blanks by the support and/or contact element, in particular by the support and/or contact elements, a reliable detection of a packaging blank characteristic variable is achievable.

It is moreover proposed that the product handling device comprises at least one movement and/or bearing unit for an, in particular translationally, movable support of the detection unit at least relative to a base body of the handling unit. The detection unit is preferably supported so as to be movable as a whole, in particular relative to the base body of the handling unit, by the movement and/or bearing unit. Alternatively or additionally, it is conceivable that the movement and/or bearing unit is configured to support the detection element and the further detection element(s) individually in such a way that they are movable relative to one another. Preferably, the movement and/or bearing unit is configured to support the detection unit as a whole and/or the individual detection elements individually in such a way that they are movable along and/or around a movement axis of the movement and/or bearing unit, which runs at least substantially parallel to the movement axis of the separation element of the handling unit, and/or along and/or around a further movement axis of the movement and/or bearing unit, which runs at least substantially parallel to the movement axis of at least one of the support and/or contact elements. Different movement axes or further movement axes are also conceivable, along and/or around which the detection unit is supported so as to be movable by the movement and/or bearing unit. The movement and/or bearing unit may be realized, for example, as a linear guide rail unit with straight and/or curved path sections, as a rotational bearing unit and/or as a different unit deemed expedient by someone skilled in the art. In an implementation of the movement and/or bearing unit as a linear guide rail unit, it is for example conceivable that the movement and/or bearing unit comprises at least one guide carriage at which the detection unit is arranged, wherein the guide carriage is supported movably on at least one guide rail of the movement and/or bearing unit, which is in particular arranged at the base body of the handling unit. Alternatively or additionally, it is conceivable that the detection unit is supported so as to be rotatable, in particular at the base body of the handling unit, by the movement and/or bearing unit. The movement and/or bearing unit is preferably arranged at the base body of the handling unit. However, it is also conceivable that the movement and/or bearing unit is realized as an independent unit, which is provided separately from the base body and by which the detection unit is movable separately from the handling unit. Further implementations and/or arrangements of the movement and/or bearing unit, deemed expedient by someone skilled in the art, are likewise conceivable. The movement and/or bearing unit may comprise at least one drive, such as for example an electric motor, a hydraulic cylinder, a pneumatic cylinder or the like, by which the detection unit is drivable for a movement. The implementation of the product handling device according to the invention advantageously enables a reliable detection of relevant packaging blank characteristic variables for a handling of packaging blanks by the handling unit. Advantageously, few movements/detection steps are sufficient to enable a precise detection of packaging blank characteristic variables. Advantageously, a reliable detection of a packaging blank characteristic variable for a reliable form-fitting holding of the packaging blanks by the support and/or contact element, in particular by the support and/or contact elements, is achievable. Advantageously, a high productivity of the packaging machine comprising the product handling device can be realized.

Moreover, it is proposed that the detection unit comprises at least one, in particular optical, distance detection element, in particular a long-distance laser sensor, for a detection of a distance of the handling unit, in particular a distance of the support and/or contact elements, relative to the packaging blanks arranged on or at the transport or storage device, preferably the pallet, relative to the cardboard magazine and/or relative to packaging blanks that are already arranged at the cardboard magazine. Preferably, the distance detection element is realized as a long-distance laser sensor. However, it is also conceivable that the distance detection element is realized as a camera, as a radar or as a different distance detection element deemed expedient by someone skilled in the art. The implementation of the product handling device according to the invention advantageously enables counteracting a collision of the handling unit with packaging blanks on or at the transport or storage device, preferably the pallet, with the cardboard magazine itself and/or with packaging blanks that are already arranged at the cardboard magazine. A high degree of automation is advantageously achievable. Advantageously, a position detection of packaging blanks on or at the transport or storage device, preferably the pallet, a position detection of the cardboard magazine relative to the handling unit and/or a position detection of packaging blanks that are already arranged at the cardboard magazine are/is enabled. Advantageously, simple and safe handling of packaging blanks is enabled. Advantageously, precise receiving and precise depositing of the packaging blanks in the cardboard magazine are enabled. Advantageously, a high productivity of the packaging machine comprising the product handling device can be realized. Advantageously, reliable handling, in particular gripping, of packaging blanks is enabled substantially independently of an orientation and/or arrangement of packaging blanks on or at a transport or storage device, preferably the pallet.

Beyond this, it is proposed that the distance detection element is arranged at an, in particular the aforementioned, base body of the handling unit, in particular between the at least one detection element and the at least one further detection element. It is also conceivable that the distance detection element is arranged at a different position, deemed expedient by someone skilled in the art, of the product handling device, such as for example at the industrial robot or the like. The implementation of the product handling device according to the invention enables realizing a compact implementation of the product handling device. Advantageously, simple and safe handling of packaging blanks is enabled. Advantageously, precise receiving and precise depositing of the packaging blanks in the cardboard magazine are enabled. Advantageously, a high productivity of the packaging machine comprising the product handling device can be realized. Advantageously, reliable handling, in particular gripping, of packaging blanks is enabled substantially independently of an orientation and/or arrangement of packaging blanks on or at a transport or storage device, preferably a pallet.

Furthermore, the invention is based on a method for a handling of stacks of packaging blanks, in particular cardboard blanks, preferably for an automatic loading of a cardboard magazine of a packaging machine with stacks of packaging blanks, by means of a product handling device, in particular a product handling device according to the invention, wherein at least one handling unit of the product handling device is open-loop controlled or closed-loop controlled by means of an open-loop or closed-loop control unit of the product handling device, wherein in at least one method step, at least one packaging blank characteristic variable, in particular an orientation and/or a dimension of the packaging blanks and/or a position of the packaging blanks on or at a transport or storage device, preferably a pallet, is detected by means of a detection unit, which packaging blank characteristic variable is taken into account by the open-loop control or closed-loop control unit for an open-loop controlling or closed-loop controlling of the handling unit. It is proposed that in at least one method step, by means of at least one, in particular optical, detection element of the detection unit, preferably the aforementioned, in particular optical, detection element of the detection unit, at least one packaging blank characteristic variable is detected, which is realized as a contour of at least one packaging blank of the packaging blanks, and in at least one, in particular further, method step, by means of at least one further, in particular optical, detection element of the detection unit, preferably the aforementioned further, in particular optical, detection element of the detection unit, at least one packaging blank characteristic variable is detected, which is realized as a position of a cutout, in particular a slot, between two side tabs of a packaging blank of the packaging blanks. The implementation of the method according to the invention advantageously enables a reliable detection of relevant packaging blank characteristic variables for a handling of packaging blanks by the handling unit. Advantageously, a reliable detection of a packaging blank characteristic variable for a reliable form-fitting holding of the packaging blanks by the support and/or contact element, in particular by the support and/or contact elements, is achievable. Advantageously, simple and safe handling of packaging blanks is enabled. Advantageously, precise receiving and precise depositing of the packaging blanks in the cardboard magazine are enabled. Advantageously, a high productivity of the packaging machine comprising the product handling device can be realized. Advantageously, a reliable handling, in particular gripping, of packaging blanks is enabled substantially independently of an orientation and/or arrangement of packaging blanks on or at a transport or storage device, preferably a pallet, in particular since an orientation and/or arrangement of packaging blanks on or at a transport or storage device, preferably a pallet, can advantageously be detected by means of the detection unit. By the implementation according to the invention, advantageously a high degree of automation is achievable. Advantageously, a checking of a stack quality of the packaging blanks is advantageously enabled, in particular in an early processing stage of the packaging blanks, which advantageously allows counteracting a machine stop.

It is further proposed that in at least one method step, a packaging blank characteristic variable that is realized as a stack height of the packaging blanks on a transport or storage device, preferably a pallet, is detected by means of the further detection element. By the implementation according to the invention, advantageously a statement can be enabled with regard to a quality of the stack of packaging blanks that is to be handled. Advantageously, depth information can be detected in order to determine a maximum height of a stack of packaging blanks that is to be handled. Advantageously, a reliable detection of relevant packaging blank characteristic variables for a handling of packaging blanks by the handling unit can be realized. Advantageously, a reliable detection of a packaging blank characteristic variable for a reliable form-fitting holding of the packaging blanks by the support and/or contact element, in particular by the support and/or contact elements, is achievable.

It is moreover proposed that in at least one, in particular additional, method step of the method, by means of at least one, in particular optical, distance detection element, in particular a long-distance laser sensor, of the detection unit, a distance of the handling unit, in particular a distance of the support and/or contact elements, relative to the packaging blanks arranged on or at the transport or storage device, preferably the pallet, relative to the cardboard magazine and/or relative to packaging blanks that are already arranged at the cardboard magazine, is detected, which packaging blank characteristic variable is taken into account by the open-loop or closed-loop control unit for an open-loop controlling or closed-loop controlling of the handling unit. The implementation of the product handling device according to the invention advantageously enables counteracting a collision of the handling unit with packaging blanks on or at the transport or storage device, preferably the pallet, with the cardboard magazine itself and/or with packaging blanks that are already arranged at the cardboard magazine. A high degree of automation is advantageously achievable. Advantageously, a position detection of packaging blanks on or at the transport or storage device, preferably the pallet, a position detection of the cardboard magazine relative to the handling unit and/or a position detection of packaging blanks that are already arranged at the cardboard magazine are/is enabled. Advantageously, simple and safe handling of packaging blanks is enabled. Advantageously, precise receiving and precise depositing of the packaging blanks in the cardboard magazine are enabled. Advantageously, a high productivity of the packaging machine comprising the product handling device can be realized. Advantageously, reliable handling, in particular gripping, of packaging blanks is enabled substantially independently of an orientation and/or arrangement of packaging blanks on or at a transport or storage device, preferably a pallet.

Furthermore, a packaging machine for a packaging of products, in particular food products, with at least one product handling device according to the invention, is proposed. The packaging machine preferably comprises at least one, in particular the aforementioned, cardboard magazine, which can be loaded, preferably fully automatically, with packaging blanks, in particular by means of the product handling device. The packaging machine may comprise further devices and/or units deemed expedient by someone skilled in the art, which may be usable for a handling of products, in particular of food products. The packaging machine is preferably configured for a production, filling, packaging and/or secondary-packaging of food products. The packaging machine may, for example, comprise, in addition to the product handling device, a forming device for packagings, a cutting device, a filling device, a sterilization device, a closure device, a secondary-packaging device, a container feed device, a packaging device or the like. The implementation of the packaging machine according to the invention advantageously enables a reliable handling of packaging blanks by the product handling device. Advantageously, a reliable detection of a packaging blank characteristic variable for a reliable form-fitting holding of the packaging blanks by the support and/or contact element, in particular by the support and/or contact elements, is achievable. Advantageously, simple and safe handling of packaging blanks is enabled. Advantageously, precise receiving and precise depositing of the packaging blanks in the cardboard magazine are enabled. Advantageously, a high productivity of the packaging machine comprising the product handling device can be realized. Advantageously, a reliable handling, in particular gripping, of packaging blanks is enabled substantially independently of an orientation and/or arrangement of packaging blanks on or at a transport or storage device, preferably a pallet, in particular since an orientation and/or arrangement of packaging blanks on or at a transport or storage device, preferably a pallet, can advantageously be detected by means of the detection unit.

The product handling device according to the invention, the method according to the invention and/or the packaging machine according to the invention shall here not be restricted to the above-described application and implementation. In particular, in order to fulfill a functionality that is described here, the product handling device according to the invention, the method according to the invention and/or the packaging machine according to the invention may have a number of individual elements, components and units as well as method steps that differs from a number given here. Moreover, as for the value ranges indicated in this disclosure, values lying within the stated limits shall also be considered as being disclosed and as being usable as desired.

### BRIEF DESCRIPTION OF THE DRAWINGS

Further advantages will become apparent from the following description of the drawings. An exemplary embodiment of the invention is shown in the drawings. The drawings, the description and the claims contain numerous features in combination. Someone skilled in the art will purposefully also consider the features individually and will find further expedient combinations.

In the drawings:

FIG. 1 shows a packaging machine according to the invention, with a product handling device according to the invention comprising at least one detection unit, in a schematic illustration,

FIG. 2 shows a detail view of the product handling device according to the invention during a run-in movement of a separation element of a handling unit of the product handling device according to the invention, in a schematic illustration,

FIG. 3 shows a detail view of the product handling device according to the invention, in a schematic illustration,

FIG. 4 shows a detail view of the product handling device according to the invention, with support and/or contact elements of the handling unit holding a stack of packaging blanks in a form-fitting manner, in particular by means of a three-point support, in a schematic illustration,

FIG. 5a shows a possible movable arrangement of the detection unit of the product handling device according to the invention by means of a movement and/or bearing unit of the product handling device according to the invention, in a schematic illustration,

FIG. 5b shows a detection process of the detection unit of the product handling device according to the invention, in a schematic illustration, and

FIG. 6 shows a flow chart of a method according to the invention for a handling of stacks of packaging blanks, in a schematic illustration.

### DETAILED DESCRIPTION

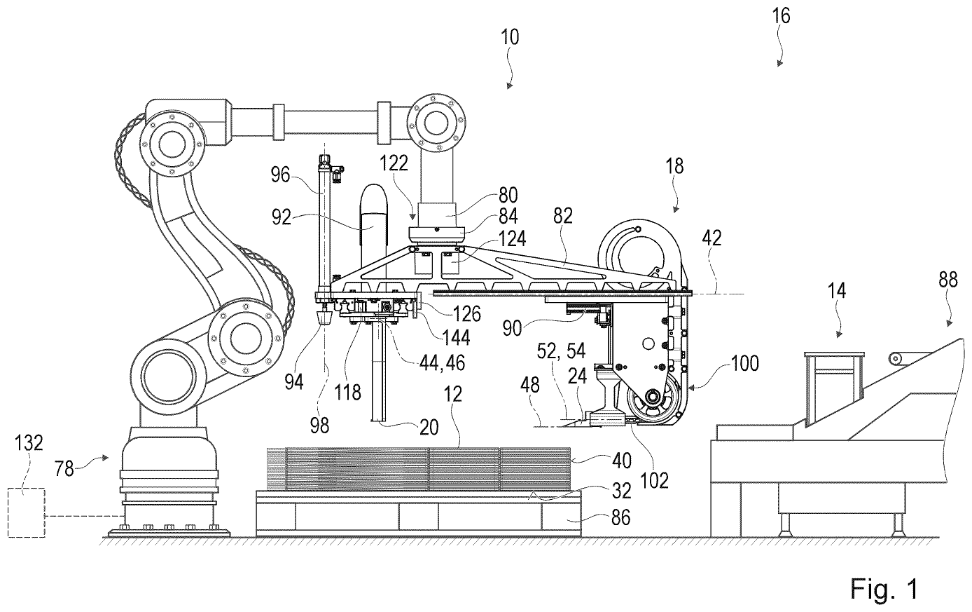

FIG. 1 shows an, in particular very simplified, illustration of a packaging machine 16 at least for a packaging of products (not shown here in detail), in particular food products, such as for example cookies, biscuits, chocolate articles or the like. The packaging machine 16 comprises at least one product handling device 10 for a handling of stacks of packaging blanks 12, in particular cardboard blanks, preferably for an automatic loading of a cardboard magazine 14 of the packaging machine 16 with stacks of packaging blanks 12. The packaging machine 16 is in particular embodied as a food production and/or food packaging machine. It is, however, also conceivable that the packaging machine 16 has a different implementation that is deemed expedient by someone skilled in the art, such as for example as a pharmaceutical production and/or pharmaceutical packaging machine or the like. The packaging machine 16 may alternatively or additionally be configured for a production, processing and/or packaging of food products, such as for example cookies, biscuits, chocolate articles or the like. The packaging machine 16 preferably comprises, in addition to the product handling device 10, further devices and/or units which are deemed expedient by someone skilled in the art and are used for a production, processing and/or packaging of food products, such as for example a sterilization device, a closure device, a secondary-packaging device or the like.

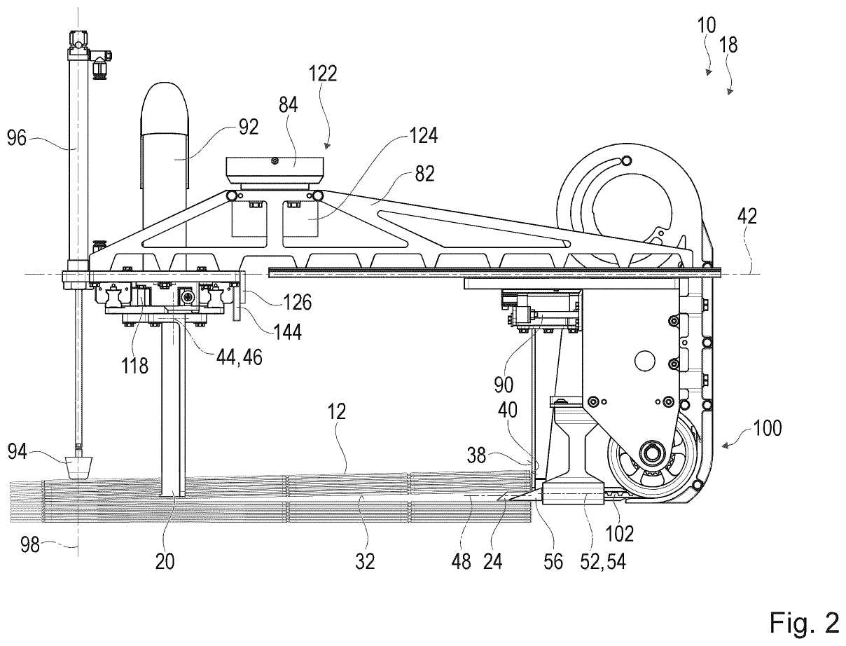

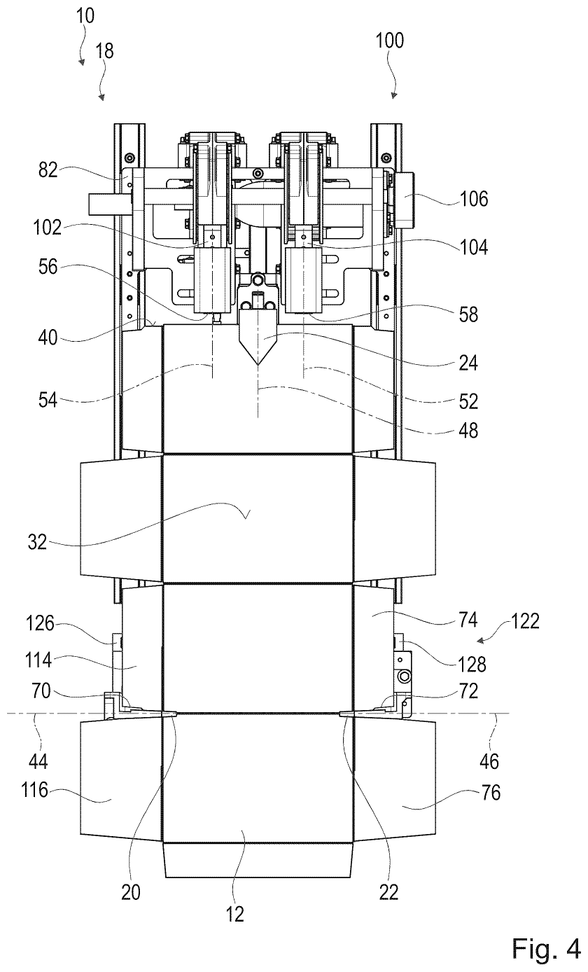

The product handling device 10 comprises at least one handling unit 18 comprising, in particular three, support and/or contact elements 20, 22, 24 which, in particular in each case, have a support surface 26, 28, 30 against which, at least during handling, the stack of packaging blanks 12 can be placed with a main extension surface 32, in particular a main extension surface 32 of an, in particular lowermost, packaging blank 12 of the stack of packaging blanks 12, which faces towards the support and/or contact elements 20, 22, 24 (cf. also FIGS. 2 and 4). At least one, in particular at least two, preferably all, of the support and/or contact elements 20, 22, 24 comprises/comprise, in particular in each case, preferably a side contact surface 34, 36, 38 which extends transversely, in particular at least substantially perpendicularly, to the support surface 26, 28, 30 and against which, at least during handling, the stack of packaging blanks 12 can be placed with a side surface 40 extending transversely to the main extension surface 32 (cf. also FIGS. 2 to 4). Preferably, the stack of packaging blanks 12 can be held by means of the at least one of the support and/or contact elements 20, 22, 24, in particular by means of at least two of the support and/or contact elements 20, 22, 24, preferably by means of all support and/or contact elements 20, 22, 24, via a form-fit connection with the handling unit 18, which acts at least substantially parallel to the main extension surface 32 of the stack of packaging blanks 12. Preferentially, during a handling by the handling unit 18, the stack of packaging blanks 12 additionally rests against the respective support surface 26, 28, 30 of the individual support and/or contact elements 20, 22, 24.

Preferably, the product handling device 10 can be arranged, in particular is arranged, on an industrial robot 78, in particular on a tool interface 80 of the industrial robot 78, or the product handling device 10 preferentially comprises the industrial robot 78 on which at least the handling unit 18 can be arranged, in particular is arranged, in particular on the tool interface 80 of the industrial robot 78. Preferably, the product handling device 10 or at least the handling unit 18 is supported by the industrial robot 78 so as to be movable rotationally around and/or translationally along at least one movement axis, preferably three movement axes, in particular relative to the packaging machine 16 and/or relative to a ground on which the industrial robot 78 is arranged. Preferably, the handling unit 18 has a base body 82, on which a connection interface 84 of the handling unit 18 is arranged for an, in particular form-fit and/or force-fit, connection of the handling unit 18 to the industrial robot 78, in particular to the tool interface 80 of the industrial robot 78. Preferentially, the handling unit 18 is, in particular detachably, fixed to the tool interface 80 of the industrial robot 78 via the connection interface 84. The connection interface 84 may, in particular in addition to a fixing of the handling unit 18 to the industrial robot 78, be configured for a power supply and/or a data connection, preferably in a manner already known to someone skilled in the art.

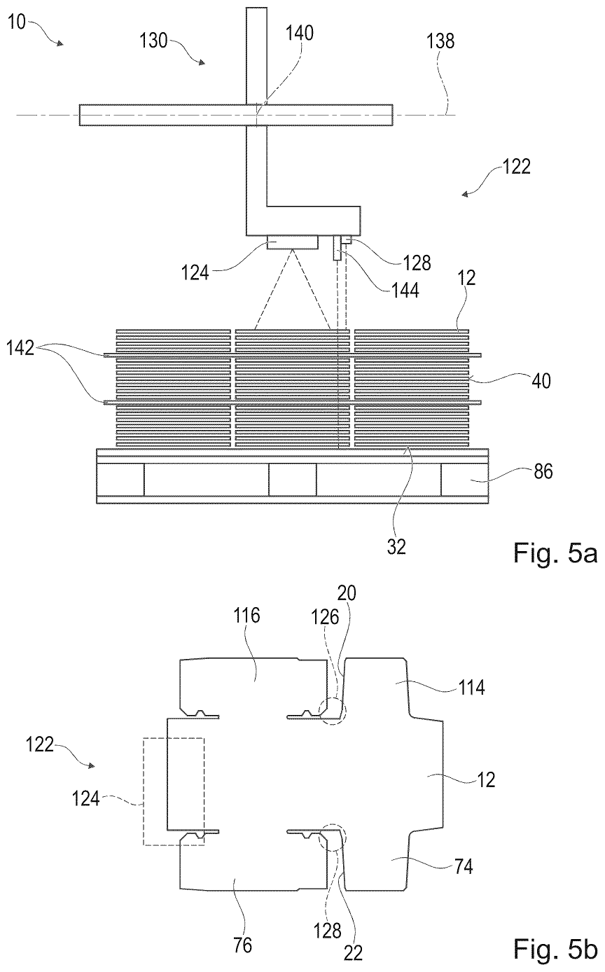

Furthermore, the product handling device 10 comprises at least one detection unit 122, which is configured to detect at least one packaging blank characteristic variable (cf. also FIG. 5b). The detection unit 122 is preferably realized as an optical detection unit. It is, however, also conceivable that the detection unit 122 has a different implementation that is deemed expedient by someone skilled in the art. Preferably, the detection unit 122 comprises at least one or several detection element(s) 124, 126, 128 which is/are realized as (an) optical sensor(s), such as for example as (a) laser sensor(s), as (a) LiDAR sensor(s), as (a) 2D or 3D laser scanner(s) or the like. Preferably, the detection unit 122 is configured at least for detecting a contour, in particular an outer contour of individual packaging blanks 12, a position of individual packaging blanks 12 relative to one another, an orientation of the packaging blanks 12 relative to one another and/or relative to a transport or storage device 86, preferably a pallet, a maximum material thickness of individual packaging blanks 12, a maximum height of a stack of packaging blanks 12, a position of an intermediate layer 142 (cf. FIG. 5a) between several stacks of packaging blanks 12, a position of one or several cutout(s) 70, 72, in particular slot(s), between two side tabs 74, 76, 114, 116 of a packaging blank 12 (cf. FIG. 5b), a distance of the cutouts 70, 72 relative to one another, and/or other packaging blank characteristic variables deemed expedient by someone skilled in the art.

The detection unit 122 may be arranged at the handling unit 18, in particular at the base body 82, or may be arranged separately from the handling unit 18. The detection unit 122 may be supported movably at the base body 82 of the handling unit 18 (cf. in this respect also, by way of example, FIG. 5a) or may be fastened stationarily at the base body 82 of the handling unit 18, in particular so as to be movable, preferably by means of the industrial robot 78, together with the handling unit 18. It is also conceivable that the detection unit 122 is movable separately from, in particular independently of, the handling unit 18. Further arrangements of the detection unit 122, deemed expedient by someone skilled in the art, are likewise conceivable, such as for example an arrangement of the detection unit 122 on a drone, on an automated guided vehicle (AGV), on an, in particular additional, industrial robot, or the like. Preferably, a pre-adjustment of a position of the support and/or contact elements 20, 22, 24 relative to the base body 82 of the handling unit 18 is executed depending on packaging blank characteristic variables detected by the detection unit 122, in particular in order to enable simple and quick adaption to packaging blanks 12 of different sizes, such as for example in the case of a format change or the like, and/or to enable safe and reliable handling, in particular gripping, of the packaging blanks 12. The product handling device 10 preferentially comprises an open-loop or closed-loop control unit 132 (cf. FIG. 1), which is connected to the detection unit 122 in terms of data technology, wherein the open-loop or closed-loop control unit 132 is configured for open-loop controlling or closed-loop controlling of the handling unit 18 depending on packaging blank characteristic variables detected by the detection unit 122.

The detection unit 122 preferably comprises at least one, in particular optical, detection element 124 and at least one further, in particular optical, detection element 126, 128, wherein the detection element 124 is configured for a detection of at least one packaging blank characteristic variable and the further detection element 126, 128 is configured for a detection of at least one further packaging blank characteristic variable. The, in particular optical, detection element 124 preferably has an implementation different from the further, in particular optical, detection element 126, 128, in particular at least with regard to a structure, wherein an operating principle may be the same, for example an implementation of the, in particular optical, detection element 124 as a line laser and of the further, in particular optical, detection element 126, 128 as a distance laser sensor, or the like. Preferentially, the, in particular optical, detection element 124 and the further, in particular optical, detection element 126, 128 are arranged spaced apart from one another, in particular at the base body 82 of the handling unit 18. The, in particular optical, detection element 124 and/or the further, in particular optical, detection element 126, 128 may be arranged in a positionally fixed manner, preferably relative to one another, in particular at the base body 82 of the handling unit 18. It is also conceivable that the, in particular optical, detection element 124 and/or the further, in particular optical, detection element 126, 128 are/is arranged so as to be movable, preferably relative to one another, in particular at the base body 82 of the handling unit 18 (cf. in this respect also, for example, FIG. 5a). Preferably, the detection unit 122 comprises a single, in particular optical, detection element 124 and at least two further, in particular optical, detection elements 126, 128. However, it is also conceivable that the detection unit 122 comprises a different number, deemed expedient by someone skilled in the art, of detection elements 124 and further detection elements 126, 128. For example, the, in particular optical, detection element 124 is configured to detect a contour, in particular an outer contour, of individual packaging blanks 12, a position of individual packaging blanks 12 relative to one another, an orientation of the packaging blanks 12 relative to one another and/or relative to the transport or storage device 86, preferably pallet, or the like. The further, in particular optical, detection element(s) 126, 128 is/are configured, for example, for detecting a maximum material thickness of at least one packaging blank 12, a maximum height of a stack of packaging blanks 12, a position of the intermediate layer 142 between several stacks of packaging blanks 12, a position of one or several cutout(s) 70, 72, in particular slot(s), between two side tabs 74, 76, 114, 116 of a packaging blank 12, a distance of cutouts 70, 72 relative to one another, or the like.

The, in particular optical, detection element 124 is preferably configured at least for a detection of a packaging blank characteristic variable that is realized as a contour of at least one packaging blank 12 of the packaging blanks 12. Preferably, the further, in particular optical, detection element(s) 126, 128 is/are configured for a detection of a packaging blank characteristic variable that is realized as a position of the cutout 70, 72, in particular the slot, between the two side tabs 74, 76, 114, 116 of a packaging blank 12 of the packaging blanks 12 (cf. FIG. 5b). The optical detection element 124 is preferably realized as a laser scanner/laser profile sensor. The further optical detection element(s) 126, 128 is/are preferably realized as (a) laser distance sensor(s). The optical detection element 124 is preferably arranged, in particular on the base body 82 of the handling unit 18, spaced apart from the further optical detection element(s) 126, 128, along a direction that runs at least substantially parallel to a movement axis 52, 54 of at least one separation element 56, 58 of the handling unit 18 (cf. FIGS. 1 to 3). The two further optical detection elements 126, 128 are preferably arranged, in particular on the base body 82 of the handling unit 18, spaced apart from one another along a direction that runs at least substantially parallel to a movement axis 44, 46 of at least one of the support and/or contact elements 20, 22 (cf. FIG. 4).

Preferably, the detection unit 122 comprises at least one, in particular optical, distance detection element 144, in particular a long-distance laser sensor, for a detection of a distance of the handling unit 18, in particular a distance of the support and/or contact elements 20, 22, 24, relative to the packaging blanks 12 arranged on or at the transport or storage device 86, preferably the pallet, relative to the cardboard magazine 14 and/or relative to packaging blanks 12 that are already arranged at the cardboard magazine 14. Preferentially, the distance detection element 144 is realized as a long-distance laser sensor. However, it is also conceivable that the distance detection element 144 is realized as a camera, as a radar or as a different distance detection element 144 deemed expedient by someone skilled in the art. The distance detection element 144 is preferably arranged at the base body 82 of the handling unit 18, in particular between the at least one detection element 124 and the at least one further detection element 126, 128. The distance characteristic variables detected by the distance detection element 144 can preferably be processed via the open-loop or closed-loop control unit 132, in particular in order to counteract a collision of the handling unit 18 with packaging blanks 12 on or at the transport or storage device 86, preferably the pallet, of the handling unit 18 with the cardboard magazine 14 and/or of the handling unit 18 with packaging blanks 12 that are already arranged at the cardboard magazine 14.

The handling unit 18 is preferably configured for a handling of stacks of packaging blanks 12. In particular, the handling unit 18 is configured for a lifting/removal of a stack of packaging blanks 12 from a plurality of packaging blanks 12 arranged on or at the transport or storage device 86, in particular a pallet, and for a subsequent transfer of the lifted/removed stack of packaging blanks 12 to the packaging machine 16, in particular to the cardboard magazine 14 or to a feed transport unit 88, preferably a so-called feeder, of the packaging machine 16. Preferentially, the plurality of packaging blanks 12 arranged on or at the transport or storage device 86, in particular the pallet, are arranged on or at the transport or storage device 86 in an ordered and/or stacked manner that is already known to someone skilled in the art. The handling unit 18 is preferably configured to hold the stack of packaging blanks 12 to be handled via a form-fit connection that acts at least substantially parallel to a main extension plane 42 of the handling unit 18.

For a handling of the stack of packaging blanks 12, the handling unit 18 preferably comprises at least the, in particular three, support and/or contact elements 20, 22, 24. In particular when viewed in a plane extending at least substantially perpendicularly to the main extension plane 42 of the handling unit 18, preferably at least one, in particular at least two, of the support and/or contact elements 20, 22, 24 is/are realized in an L-shaped manner, wherein one leg of the L-shaped implementation forms the support surface 26, 28, 30 and a further leg of the L-shaped implementation forms the side contact surface 34, 36, 38. Preferentially, all three support and/or contact elements 20, 22, 24 are realized in an L-shaped manner. Two of the, in particular three, support and/or contact elements 20, 22, 24 are preferably realized as side-tab-slot-engagement elements which, for a handling of the stack of packaging blanks 12, are insertable into the cutout 70, 72, in particular the slot, between the two side tabs 74, 76, 114, 116 of the packaging blanks 12 (cf. FIG. 4). However, it is also conceivable that, alternatively or additionally, the two support and/or contact elements 20, 22 are configured for a gripping of the side tabs 74, 76, 114, 116 of the packaging blanks 12, in particular in a region of the side tabs 74, 76, 114, 116 of the packaging blanks 12 outside the cutouts 70, 72. At least one of the, in particular three, support and/or contact elements 20, 22, 24 is preferably realized as a gripping finger, in particular as a primary gripping finger, which can be brought into contact/is brought into contact with the stack of packaging blanks 12 before the side-tab slot-engagement elements.

Preferentially, the, in particular three, support and/or contact elements 20, 22, 24 are supported movably at the base body 82 of the handling unit 18, in particular relative to one another, relative to the industrial robot 78 and/or relative to the packaging machine 16. Preferably, individual movement axes 44, 46, 48 of the, in particular three, support and/or contact elements 20, 22, 24 in each case extend at least substantially parallel to the main extension plane 42 of the handling unit 18. Preferably, at least two movement axes 44, 46 of the, in particular three, support and/or contact elements 20, 22, 24 extend coaxially, in particular the movement axes 44, 46 of the support and/or contact elements 20, 22 realized as side-tab slot-engagement elements. At least one movement axis 48 of the, in particular three, support and/or contact elements 20, 22, 24, in particular the movement axis 48 of the support and/or contact element 24 that is realized as a gripping finger, extends transversely, in particular at least substantially perpendicularly, to the two coaxially extending movement axes 44, 46 of the support and/or contact elements 20, 22 that are realized as side-tab-slot engagement elements.

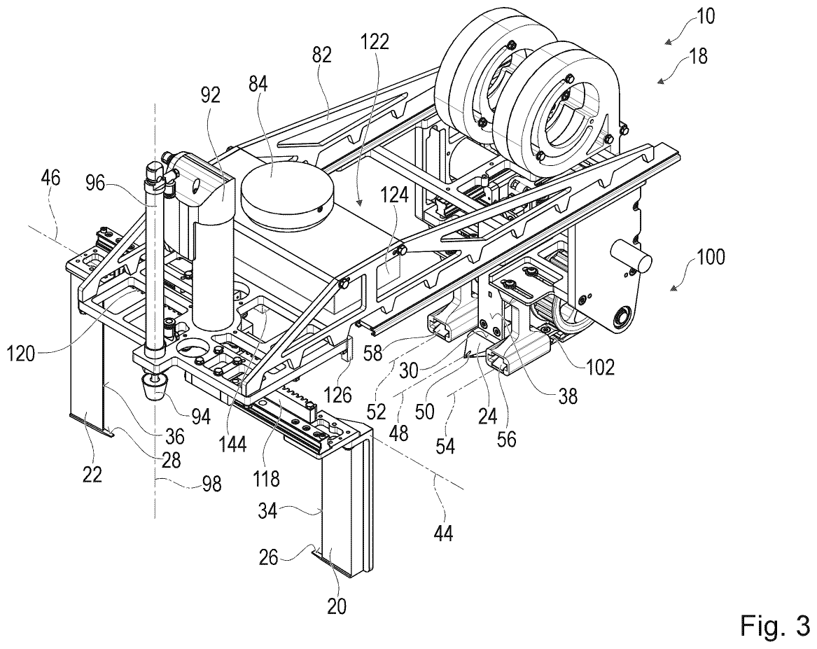

Preferably, the support and/or contact elements 20, 22, 24 are, in particular in each case, supported so as to be—in particular translationally - movable relative to one another along their movement axes 44, 46, 48, which extend at least substantially parallel to the support surface 26, 28, 30. For a movement of the support and/or contact elements 20, 22, 24, in particular relative to the base body 82, the handling unit 18 preferably comprises at least one drive 90, 92, such as for example an electric motor, a hydraulic cylinder, a pneumatic cylinder or the like. Preferentially, the handling unit 18 comprises at least two drives 90, 92 for a movement of the support and/or contact elements 20, 22, 24. Preferably, one of the drives 90, 92 is configured for a movement of the support and/or contact element 24 that is realized as a gripping finger. The drive 90 for a movement of the support and/or contact element 24 realized as a gripping finger is preferably embodied as a pneumatic or hydraulic cylinder (cf. FIG. 2). Preferably, one of the drives 90, 92 is configured for an, in particular common but opposed, movement of the support and/or contact elements 20, 22 that are realized as side-tab slot-engagement elements. The drive 92 for a movement of the support and/or contact elements 20, 22 realized as side-tab slot-engagement elements is preferably embodied as an electric motor cooperating with toothed rods 118, 120 of the handling unit 18, which are arranged at the support and/or contact elements 20, 22 as side-tab slot-engagement elements (cf. FIG. 3). However, it is also conceivable that the drives 90, 92 have a different implementation deemed expedient by someone skilled in the art and/or cooperate with the support and/or contact elements 20, 22, 24 in a different manner deemed expedient by someone skilled in the art, in order to move the support and/or contact elements 20, 22, 24 relative to the base body 82.

Preferably, the handling unit 18 comprises at least one press-on element 94, which is configured, in particular temporarily, to exert a force on the stack of packaging blanks 12 acting along a direction that runs at least substantially perpendicularly to the main extension plane 42 of the handling unit 18 (cf. FIG. 2). The press-on element 94 is preferably supported so as to be movable at the base body 82 of the handling unit 18, in particular supported so as to be movable translationally. A movement axis 98 of the press-on element 94 preferably extends transversely, in particular at least substantially perpendicularly, to the main extension plane 42 of the handling unit 18. It is also conceivable that the press-on element 94 is supported at the base body 82 so as to be movable around and/or along a differently oriented movement axis 98 relative to the base body 82. Preferably, the press-on element 94 is drivable by an additional drive 96 of the handling unit 18, in particular an electric motor, a hydraulic cylinder, a pneumatic cylinder or the like. The press-on element 94 is preferably arranged on a side of the base body 82 of the handling unit 18 facing away from the support and/or contact element 24 that is realized as a gripping finger.

The handling unit 18 preferably comprises at least one insertion aid element 50, which acts on the stack of packaging blanks 12 in particular via compressed air and which is configured for a moving apart of the stack of packaging blanks 12 to be handled and further packaging blanks 12, which are in particular arranged on or at the transport or storage device 86, preferably the pallet (cf. FIG. 3). The insertion aid element 50 is preferably realized as a compressed-air nozzle. However, it is also conceivable that the insertion aid element 50 has a different implementation, deemed expedient by someone skilled in the art and suitable for a moving apart of the stack of packaging blanks 12 and further packaging blanks 12, which are in particular arranged on or at the transport or storage device 86, preferably the pallet. The insertion aid element 50 is preferably realized in a one-part implementation with one of the support and/or contact elements 20, 22, 24, in particular with the support and/or contact element 24 realized as a gripping finger. However, it is also conceivable that the insertion aid element 50 is realized, separately from the support and/or contact elements 20, 22, 24, as an independent, in particular movably supported element, in particular as a separate compressed-air lance or the like. It is also conceivable that each of the support and/or contact elements 20, 22, 24 is assigned its own insertion aid element 50 or that each of the support and/or contact elements 20, 22, 24 is realized in a one-part implementation with an insertion aid element 50 that is realized as a compressed-air nozzle. Preferentially, the insertion aid element 50 is configured for a fanning out of the stack of packaging blanks 12 and the further packaging blanks 12, which are in particular arranged on or at the transport or storage device 86, preferably the pallet, in particular in order to enable simple separation of the stack of packaging blanks 12 to be handled by the handling unit 18 and the further packaging blanks 12, which are in particular arranged on or at the transport or storage device 86, preferably the pallet. Preferably, the insertion aid element 50 is configured for a moving apart of the stack of packaging blanks 12 and further packaging blanks 12, which are in particular arranged on or at the transport or storage device 86, preferably the pallet, in order to assist with or facilitate at least a moving-in of at least one of the support and/or contact elements 20, 22, 24, in particular of the support and/or contact element 24 realized as a gripping finger. Preferably, via the insertion aid element 50, prior to a moving-in of at least one of the support and/or contact elements 20, 22, 24, in particular of the support and/or contact element 24 realized as a gripping finger, compressed air can be introduced between the stack of packaging blanks 12 and the further packaging blanks 12, which are in particular arranged on or at the transport or storage device 86, preferably the pallet, in order to induce a moving apart of the stack of packaging blanks 12 and the further packaging blanks 12, which are in particular arranged on or at the transport or storage device 86, preferably the pallet.

The handling unit 18 preferably comprises at least the separation element 56, 58, which is supported so as to be movable, in particular translationally movable, relative to the support and/or contact elements 20, 22, 24 along a movement axis 52, 54 that runs at least substantially parallel to the support surface 26, 28, 30, said separation element 56, 58 being configured to at least partly separate, in particular at least partly lift, the stack of packaging blanks 12 to be handled from further packaging blanks 12, in particular after the stack of packaging blanks 12 has been lifted, by means of the insertion aid element 50, from the further packaging blanks 12, which are in particular arranged on or at the transport or storage device 86, preferably the pallet. The separation element 56, 58 is preferably supported movably at the base body 82 of the handling unit 18. Preferentially, the separation element 56, 58 is realized as a wedge-shaped insertion element. The handling unit 18 preferably comprises a further drive 100 for a moving of the separation element 56, 58 (cf. FIG. 4). The further drive 100 may be realized as a belt drive, as a chain drive, as an electric drive, as a hydraulic drive, as a pneumatic drive or the like. Particularly preferably, the further drive 100 is realized as a belt drive comprising a toothed belt 102, 104 for a translational moving of the separation element 56, 58 and an electric motor 106 for a driving of the toothed belt 102, 104. The toothed belt 102, 104 is preferably realized as a finite, linearly displaceable toothed belt 102, 104, which is extendable or retractable via a roller that is drivable by the electric motor 106, in particular in order to realize a translational movement of the separation element 56, 58. A movement axis 52, 54 of the separation element 56, 58 preferably extends at least substantially parallel to a movement axis 44, 46, 48 of at least one of the support and/or contact elements 20, 22, 24, in particular the movement axis 48 of the support and/or contact element 24 that is realized as a gripping finger. Preferably, the handling unit 18 comprises at least two, in particular translationally, movably supported separation elements 56, 58. The two separation elements 56, 58 are preferably arranged so as to be laterally offset from the support and/or contact element 24 realized as a gripping finger, in particular in such a way that - viewed along a direction that runs at least substantially perpendicularly to the movement axis 48 of the support and/or contact element 24 realized as a gripping finger - the support and/or contact element 24 realized as a gripping finger is arranged between the separation elements 56, 58 (cf. FIGS. 3 and 4).

FIG. 5a shows a possible movable arrangement of the detection unit 122 by means of a movement and/or bearing unit 130 of the product handling device 10 for an, in particular translationally, movable support of the detection unit 122 at least relative to the base body 82 of the handling unit 18. The detection unit 122 is preferably supported so as to be movable as a whole, in particular relative to the base body 82 of the handling unit 18, by means of the movement and/or bearing unit 130. Alternatively or additionally, it is conceivable that the movement and/or bearing unit 130 is configured to support the detection element 124 and the further detection element(s) 126, 128 in such a way that they are individually movable relative to one another. Preferably, the movement and/or bearing unit 130 is configured to support the detection unit 122 as a whole and/or the individual detection elements 124, 126, 128 individually in such a way that they are movable along and/or around a movement axis 138 of the movement and/or bearing unit 130, which runs at least substantially parallel to the movement axis 52, 54 of the separation element 56, 58 of the handling unit 18, and/or along and/or around a further movement axis 140 of the movement and/or bearing unit 130, which runs at least substantially parallel to the movement axis 44, 46 of at least one of the support and/or contact elements 20, 22. Different movement axes or further movement axes are also conceivable, along and/or around which the detection unit 122 is supported movably by the movement and/or bearing unit 130. The movement and/or bearing unit 130 preferably comprises at least one drive (not shown here in detail), such as for example an electric motor, a hydraulic cylinder, a pneumatic cylinder or the like, by means of which the detection unit 122 is drivable for a movement.

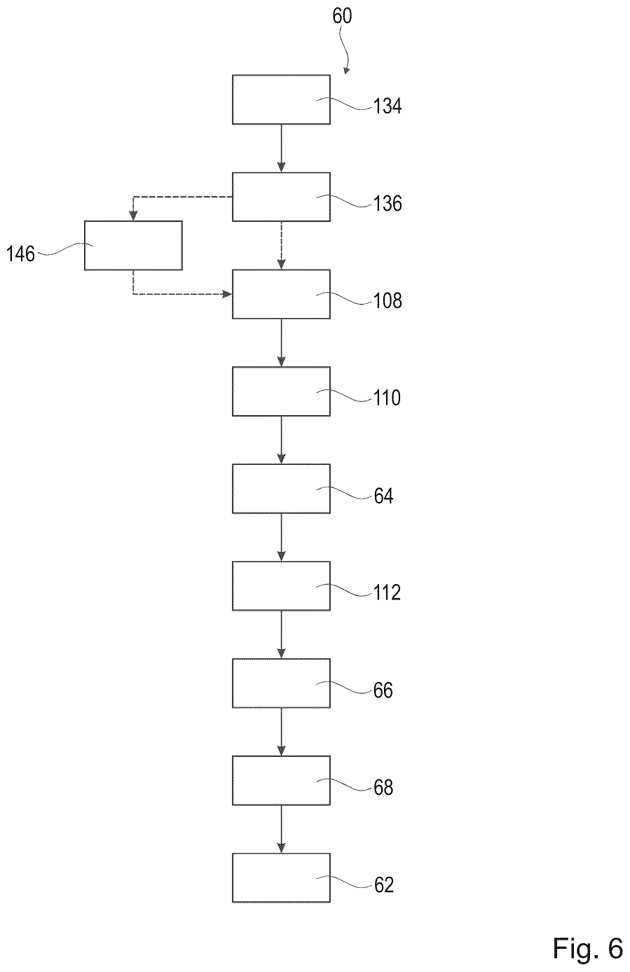

FIG. 6 shows a schematic progress flow of a method 60 for a handling of stacks of packaging blanks 12, in particular cardboard blanks, preferably for an automatic loading of the cardboard magazine 14 of the packaging machine 16 with stacks of packaging blanks 12 by means of the product handling device 10, wherein at least the handling unit 18 of the product handling device 10 is open-loop controlled or closed-loop controlled by means of the open-loop or closed-loop control unit 132 of the product handling device 10. In at least one method step 134 of the method 60, by means of the detection unit 122, at least one packaging blank characteristic variable, in particular a contour, an orientation and/or a dimension of the packaging blanks 12 and/or a position of the packaging blanks 12 on or at the transport or storage device 86, preferably the pallet, is detected, which packaging blank characteristic variable is taken into account by the open-loop or closed-loop control unit 132 for an open-loop or closed-loop controlling of the handling unit 18. Preferably, in at least one, in particular the, method step 134 of the method 60, by means of at least the, in particular optical, detection element 124 of the detection unit 122, at least one packaging blank characteristic variable is detected, which is realized as a contour of at least one packaging blank 12 of the packaging blanks 12. Preferably, in at least one, in particular further, method step 136 of the method 60, by means of at least the further, in particular optical, detection element/s 126, 128 of the detection unit 122, at least one packaging blank characteristic variable is detected, which is realized as a position of the cutout 70, 72, in particular the slot, between two side tabs 74, 76, 114, 116 of a packaging blank 12 of the packaging blanks 12. Preferably, in at least one, in particular the further, method step 136 of the method 60, by means of the further detection element/s 126, 128, a packaging blank characteristic variable is detected, which is realized as a stack height of the packaging blanks 12 on the transport or storage device 86, preferably the pallet. Preferably, in at least one, in particular additional, method step 146 of the method 60, by means of at least the, in particular optical, distance detection element 144, in particular long-distance laser sensor, of the detection unit 122, a distance of the handling unit 18, in particular a distance of the support and/or contact elements 20, 22, 24, relative to the packaging blanks 12 arranged on or at the transport or storage device 86, preferably the pallet, relative to the cardboard magazine 14 and/or relative to packaging blanks 12 that are already arranged at the cardboard magazine 14 is detected, which distance is taken into account by the open-loop or closed-loop control unit 132 for an open-loop or closed-loop controlling of the handling unit 18. The handling unit 18 is preferably open-loop or closed-loop controlled by means of the open-loop or closed-loop control unit 132 depending on data detected by means of the detection unit 122.

Preferably, in at least one method step 108 of the method 60, the handling unit 18 is moved by the industrial robot 78 into a vicinity of the transport or storage device 86 at or on which packaging blanks 12 are arranged in a stacked manner, in particular in such a way that at least a portion of the packaging blanks 12 are arranged in a region between the support and/or contact elements 20, 22, 24. In at least one method step 110 of the method 60, the press-on element 94 is preferably moved towards the packaging blanks 12, in particular until the press-on element 94 rests against the uppermost packaging blank 12, and a force is exerted, in the direction of the transport or storage device 86, onto the packaging blanks 12 arranged at or on the transport or storage device 86. Preferably, moreover, in at least one method step 64 of the method 60, by means of the insertion aid element 50 of the handling unit 18, a fluid, in particular compressed air, is introduced between the stack of packaging blanks 12 to be handled and the further packaging blanks 12 which the stack of packaging blanks 12 to be handled rests upon. Preferably, in at least one method step 112 of the method 60, at least one of the support and/or contact elements 20, 22, 24, in particular the support and/or contact element 24 realized as a gripping finger, is moved in between the stack of packaging blanks 12 to be handled and the further packaging blanks 12, in particular into the gap that is created or has been created, by the introduction of the fluid, between the stack of packaging blanks 12 to be handled and the further packaging blanks 12. Preferentially, in at least one method step 66 of the method 60, in particular after an introduction of the fluid and/or of the support and/or contact element 24 realized as a gripping finger, at least one or both of the separation elements 56, 58 is/are introduced between the stack of packaging blanks 12 to be handled and the further packaging blanks 12 which the stack of packaging blanks 12 to be handled rests upon, in particular in order to lift the stack of packaging blanks 12 to be handled in such a way that at least one, in particular both, of the support and/or contact elements 20, 22 realized as side-tab slot-engagement elements is/are movable under the stack of packaging blanks 12 to be handled, in particular is/are moved between the stack of packaging blanks 12 to be handled and the further packaging blanks 12. Preferably, in at least one method step 68 of the method 60, at least one, in particular both, of the support and/or contact elements 20, 22 realized as side-tab slot-engagement elements is/are moved into the respective cutout 70, 72 between the respective two side tabs 74, 76, 114, 116 of the packaging blanks 12. In particular, in at least one method step 62 of the method 60, the stack of packaging blanks 12 is transported to the packaging machine 16. Preferably, during handling, in at least the method step 62, the stack of packaging blanks 12 that is to be handled by means of the handling unit 18 is held via a form-fit connection that acts at least substantially parallel to the main extension plane 42 of the handling unit 18. The method 60 for a handling of stacks of packaging blanks 12 may have further method steps deemed expedient by someone skilled in the art. Moreover, possible method steps that may be derived from the description of FIGS. 1 to 4 shall be considered as being disclosed for the method 60.

1. A product handling device for a handling of stacks of packaging blanks (12), comprising:
at least one handling unit (18) comprising support and/or contact elements (20, 22, 24) which have a support surface (26, 28, 30) against which, at least during handling, the stack of packaging blanks (12) can be placed with a main extension surface (32), and
at least one detection unit (122) which is configured for the detection of at least one packaging blank characteristic variable; wherein the at least one detection unit (122) comprises at least one detection element (124) for a detection of a packaging blank characteristic variable that is configured as a contour of at least one packaging blank (12) of the packaging blanks (12), and comprises at least one further detection element (126, 128) for a detection of a packaging blank characteristic variable that is configured as a position of a cutout (70, 72) between two side tabs (74, 76, 114, 116) of a packaging blank (12) of the packaging blanks (12).

2. The product handling device according to claim 1, wherein the at least one detection unit (122) comprises the at least one optical detection element (124), which is configured as a laser scanner/laser profile sensor, and comprises the at least one further optical detection element (126, 128), which is configured as a laser distance sensor.

3. The product handling device according to claim 1, further comprising at least one movement and/or bearing unit (130) for a movable support of the at least one detection unit (122) at least relative to a base body (82) of the at least one handling unit (18).

4. The product handling device according to claim 1, wherein the at least one detection unit (122) comprises at least one distance detection element (144) for a detection of a distance of the at least one handling unit (18) relative to the packaging blanks (12) arranged on or at the transport or storage device (86) relative to the cardboard magazine (14) and/or relative to packaging blanks (12) already arranged at the cardboard magazine (14).

5. The product handling device according to claim 4, wherein the at least one distance detection element (144) is arranged at a base body (82) of the at least one handling unit (18).

6. A method for a handling of stacks of packaging blanks (12) by the product handling device according to claim 1, wherein the at least one handling unit (18) of the product handling device is open-loop controlled or closed-loop controlled by an open-loop or closed-loop control unit (132) of the product handling device, wherein in at least one method step (134), by means of the at least one detection unit (122), at least one packaging blank characteristic variable is detected, which packaging blank characteristic variable is taken into account by the open-loop or closed-loop control unit (132) for an open-loop controlling or closed-loop controlling of the at least one handling unit (18), wherein in at least one method step (134), by means of the at least one detection element (124) of the at least one detection unit (122), at least one packaging blank characteristic variable is detected which is configured as a contour of at least one packaging blank (12) of the packaging blanks (12), and in at least one method step (136), by means of the at least one further detection element (126, 128) of the detection unit (122), at least one packaging blank characteristic variable is detected which is configured as a position of a cutout (70, 72) between two side tabs (74, 76, 114, 116) of a packaging blank (12) of the packaging blanks (12).

7. The method according to claim 6, wherein in at least one method step (136), by means of the at least one further detection element (126, 128), a packaging blank characteristic variable is detected which is configured as a stack height of the packaging blanks (12) on a transport or storage device (86).

8. The method according to claim 6, wherein in at least one method step (146), by means of at least one distance detection element (144) of the detection unit (122), a distance of the handling unit (18) relative to the packaging blanks (12) arranged on or at the transport or storage device (86), relative to the cardboard magazine (14) and/or relative to packaging blanks (12) already arranged at the cardboard magazine (14), is detected, which packaging blank characteristic variable is taken into account by the open-loop or closed-loop control unit (132) for an open-loop controlling or closed-loop controlling of the handling unit (18).

9. A packaging machine for a packaging of products, comprising at least one product handling device according to claim 1.
